(19) United States
(12) Patent Application Publication
(10) Pub. No.: US 2003/0117347 A1
(43) Pub. Date: Jun. 26, 2003

(54) Active matrix electroluminescent display device

(75) Inventors: Iain M. Hunter, Brighton (GB); Mark J. Childs, Sutton (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/323,235

(22) Filed: Dec. 18, 2002

(30) Foreign Application Priority Data
Dec. 21, 2001 (GB) 0130600.0

(51) Int. Cl. G09G 3/30

(52) U.S. Cl. 345/76

(57) ABSTRACT

An active matrix electroluminescent (EL) display device comprises a matrix array of display cells (10) arranged in rows and columns, each cell comprising an EL display element (20) and driving circuitry. The cells are arranged in groups (12) which may constitute pixels. Each group of cells forms a series arrangement arranged so a data signal applied to the first cell in a series arrangement, via an associated data line (14), can be transferred to a neighbouring cell in the same group, and so on for subsequent cells in the group, upon application of a control signal applied to an associated control line (15). This device enables a digital drive scheme to be implemented. The provision of grouped display cells arranged so as to be driven in this way enables a grey scale to be implemented using fewer data lines (14) than usual.

This invention relates to active matrix electroluminescent display devices comprising a matrix array of display cells arranged in rows and columns. The invention is particularly concerned with display devices in which the display cells are driven digitally.

Matrix display devices employing electroluminescent, light-emitting, display elements are well known. As for the display elements organic thin film electroluminescent elements and light-emitting diodes (LEDs), comprising traditional III-V semiconductor compounds, have been used. Recent developments in (organic) polymer electroluminescent materials have demonstrated their ability to be used practically for video display purposes and the like. Electroluminescent elements using such materials typically comprise one or more layers of a semiconducting conjugated polymer sandwiched between a pair of (anode and cathode) electrodes, one of which is transparent and the other of which is of a material suitable for injecting holes or electrons into the polymer layer. The polymer material can be fabricated using a CVD process or simply by a spin-coating technique using a solution of a soluble conjugated polymer.

Organic electroluminescent materials exhibit diode-like I-V properties, so that they are capable of providing both a display and a switching function, and can therefore be used in passive type displays.

However, the invention is concerned with active matrix display devices, with each display cell comprising a display element and addressing circuitry for controlling the current through the display element.

An example of such an active matrix addressed electroluminescent display device is described in EP-A-0717446. In this, the address circuitry for each display cell comprises two TFTs (thin film transistors) and a storage capacitor. The anode of the display element is connected to the drain of the second TFT and the first TFT is connected to the gate of the second TFT which is connected also to one side of the capacitor. During a row address period, the first TFT is turned on by means of a row selection (gating) signal and a drive (data) signal is transferred via this TFT to the capacitor. After the removal of the selection signal the first TFT turns off and the voltage stored on the capacitor, constituting a gate voltage for the second TFT, is responsible for operation of the second TFT which is arranged to deliver electrical current to the display element. The gate of the first TFT is connected to a gate line (row conductor) common to all display elements in the same row and the source of the first TFT is connected to a data line (column conductor) common to all display elements in the same column. The drain and source electrodes of the second TFT are connected to the anode of the display element and a ground line which extends parallel to the data line and is common to all display elements in the same column. The other side of the capacitor is also connected to this ground line.

The drive signals supplying the video information can be analogue. In this case, the voltage applied to the gate of the second, current controlling, TFT, determines the grey scale (brightness level) of the output light. Ideally, the gate voltage-luminous intensity relationship should be linear. However, in practice, this relationship is non-linear due to the irregular conductance properties of the current controlling TFTs. This results in non-uniform luminous intensities being exhibited by the display elements for a given drive (data) level.

Digital addressing can be used to overcome this problem. EP-A-0949603 describes digital addressing in detail and its contents are incorporated herein by reference. In summary, the display cells are addressed with digital data signals such that each electroluminescent display element within each cell is simply switched between a fully OFF state and a fully ON state. This eliminates the non-uniformity in the luminous intensities as viewed under the analogue addressing scheme described above. In addition, this reduces the power consumption in the address circuitry, because the TFTs are no longer required to operate in the linear region as a current source.

When addressed digitally, grey scale can be achieved by forming each pixel in the display device with more than one individually-operable display cell. This is commonly referred to as area ratio grey scale and is described also in detail in EP-A-1024472. Each display cell within a pixel is controllable by respective address circuitry comprising, for example, TFTs. Varying degrees of grey scale are achieved by switching ON various combinations of the display elements within a pixel thus switching on a pre-determined area of that pixel. The display elements within a pixel may be of different luminous intensities and/or different sizes in order to increase the range of achievable grey scales.

A problem with active matrix electroluminescent display devices using area ratio addressing schemes is that many address lines are required to control the individual display cells separately. For each extra cell, an extra data line is required to supply the data information to that cell. These additional lines reduce the aperture of the pixel. This in turn means an increase in the current required through the pixel to maintain a given brightness. Moreover, the complexity of fabricating the device is increased thus increasing manufacturing costs.

It is an object of the present invention to provide an improved active matrix electroluminescent display device.

It is another object of the present invention to provide an active matrix electroluminescent display device using area ratio grey scaling which allows a reduction in the number of address lines required to supply the data information.

According to one aspect of the present invention there is provided an active matrix electroluminescent display device comprising a matrix array of display cells arranged in rows and columns, each cell comprising an electroluminescent display element and driving circuitry for controlling the current through the display element in response to applied data signals, driver means for driving the cells, the cells being organised in groups with each group comprising a plurality of adjacent cells within the same row which are connected in a series arrangement, each group having an associated data line through which data signals are supplied from the driver means, each row of cells having an associated control line through which control signals are supplied from the driver means, wherein the driver means is arranged so as to supply a data signal to the first cell within a group via its associated data line and that first cell is arranged to transfer the data signal to a neighbouring cell in the same group upon application of a control signal to its associated control line.

With a succession of cells in a given group operating in a similar manner, the driver means need only supply a data signal, via an associated data line, to the first display cell within the group, with the cells themselves serving to pass data signals from one to the other. Each display cell holds (stores) the applied data signal until an applied control signal acts to transfer the stored data signal to the next cell in the series arrangement. The manner of operation of the series arrangement of the cells is thus analogous to the operation of a shift register type circuit. Only one data line is required to address each group of display cells. The aforementioned problems relating to the use of many address lines per group are thus alleviated.

Preferably, each cell after the first in the series arrangement is adapted so as to receive a data signal from the preceding cell in the series arrangement in response to an applied control signal to the control line. Data signals supplied to the first cell are thus transferred from cell to cell, in sequence, in response to corresponding, pulsed, control signals. This manner of operation is repeated to allow the supply and transfer of data signals through the series arrangement such that each cell, within a group, is addressed with, and stores, its desired data signal during a row address period.

As in conventional display devices each cell may have an associated voltage supply line for supplying a current to the display element, and also a ground line serving as a current drain for the display element. Preferably a voltage supply line is shared by all display cells in the same row or column. Respective supply lines may be provided for each row or column of display cells. Alternatively, supply lines could effectively be shared by all the display cells in the array using, for example, lines extending in the column or row direction and connected together at their ends or by using lines extending in both the column and the row directions and connected together in the form of a grid. The approach selected will depend on the technological details for a given design and fabrication process.

Each group of cells preferably constitutes a display pixel. However, it is envisaged that each group may form a plurality of pixels or maybe even an entire row of pixels. In the latter arrangement, only one data line would be required to address the entire row, and also the entire array of display cells but at the expense perhaps of the time required to address a given row. In such an arrangement, the one data line is connected to the first display cell of each row.

Preferably, the driving circuitry of each cell is arranged so as to switch its associated display element between an off-state and an on-state in response to digital data signals supplied to that cell.

The driving circuitry may comprise transistors and all transistors may conveniently be formed as TFTs on a substrate of glass or other insulating material together with address (data and control) conductors using standard thin film deposition and patterning processes as used in the field of active matrix display devices and other large area electronic devices. It is envisaged, however, that the active matrix circuitry of the device may be fabricated using IC technology with a semiconductor substrate.

According to another aspect of the present invention there is also provided a method of driving an active matrix electroluminescent display device comprising a matrix array of display cells arranged in rows and columns, each cell comprising an electroluminescent display element, the cells being organised in groups, each group comprising a plurality of adjacent cells within the same row and which are connected to their neighbouring cells in a series arrangement and having an associated data line, each row of cells having an associated control line, the method comprising the steps of:

addressing a group of cells in a row with respective data signals by applying a data signal to the first cell in the group via its associated data line; and,

applying a control signal to the row of cells via its associated control line so as to transfer a data signal from one cell to a neighbouring cell in a group.

Embodiments of active matrix electroluminescent display devices in accordance with the invention will now be described, by way of example, with reference to the accompanying drawings, in which:

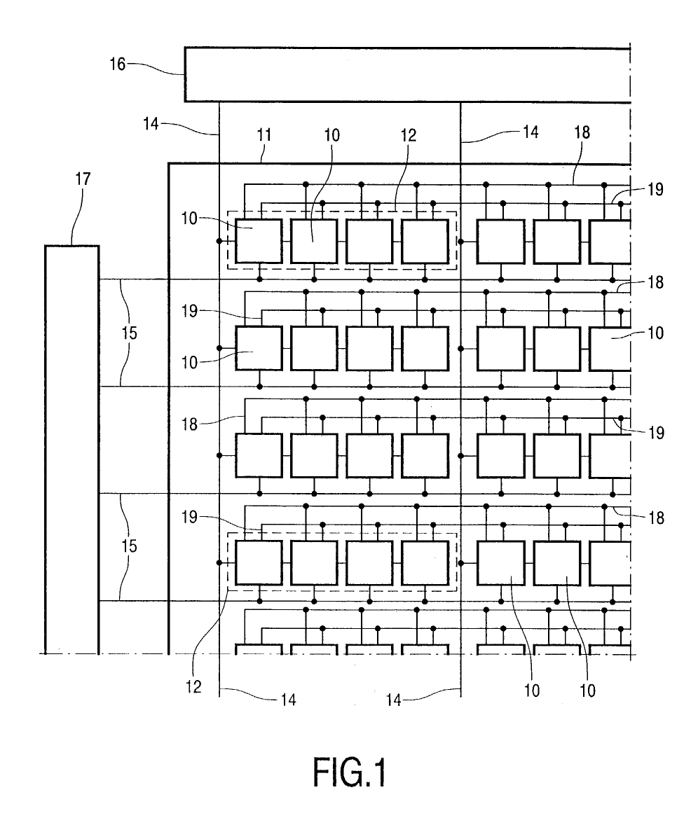

FIG. 1 is a simplified schematic diagram of part an embodiment of display device according to the invention;

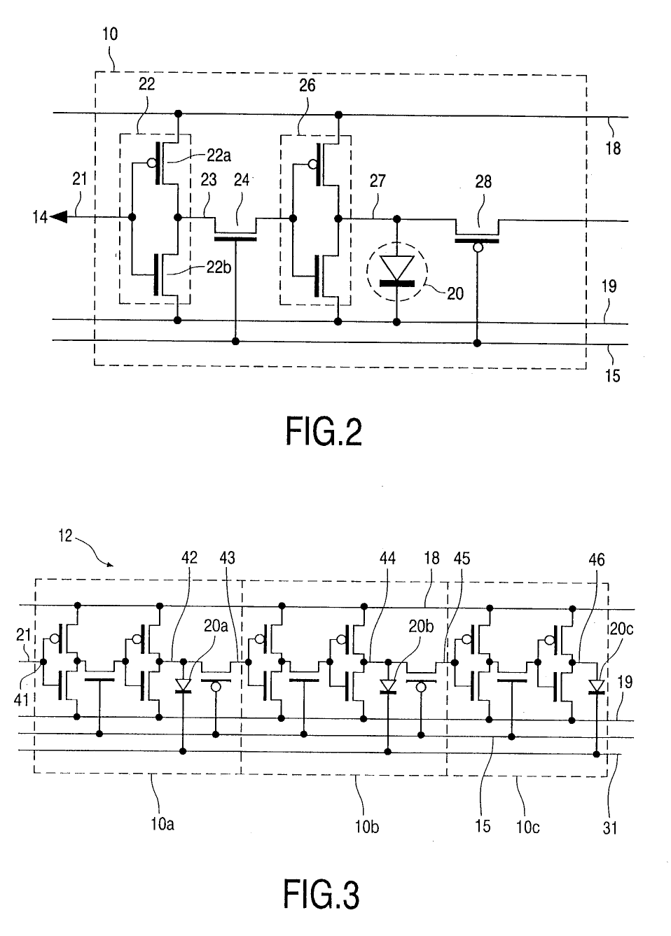

FIG. 2 shows the circuitry of a typical cell in an embodiment of the invention;

FIG. 3 shows the circuitry of a pixel in another embodiment of the invention;

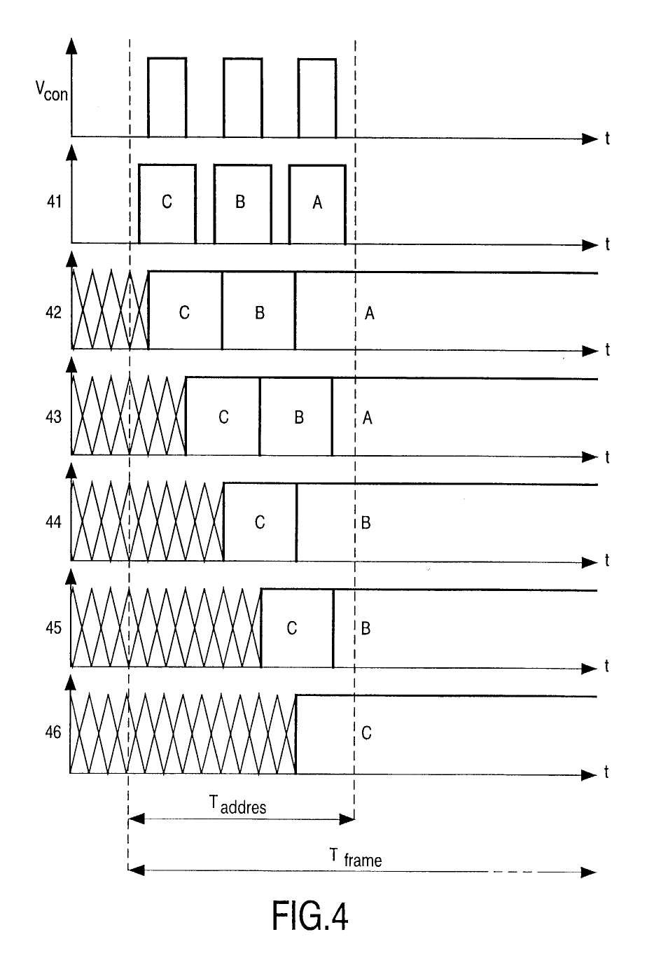

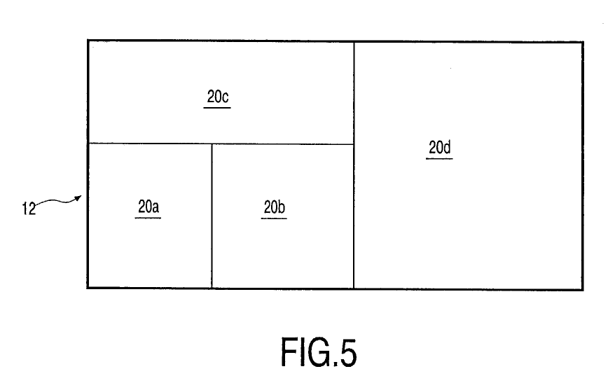

FIG. 4 is a diagram illustrating the progression of data signals through the pixel of FIG. 3; and

FIG. 5 shows an example pixel configuration having four display cells.

The figures are merely schematic and have not been drawn to scale. The same reference numbers are used throughout the figures to denote the same or similar parts.

Referring to FIG. 1, the active matrix electroluminescent display device comprises a panel 11 having a row and column array of regularly spaced display cells, denoted by the blocks 10 and comprising an electroluminescent display element together with address circuitry. The display cells 10 are arranged in groups 12, in this example with each group comprising four cells, forming respective display pixels and are arranged within each group in a series arrangement each being connected to their neighbouring cell. The cells 10 are arranged such that the display pixels 12 are regularly spaced in rows and columns forming a matrix array of pixels. Sets of column conductors extend vertically across the array forming data lines 14. Each column of pixels shares a respective data line 14, with the first cell 10 of each pixel 12 being connected to its respective data line 14. Sets of row conductors extend horizontally, crossing the column conductors and forming control lines 15. Each row of display cells shares a control line 15 with each cell being connected to its respective control line 15. Only a few pixels are shown in the Figure for simplicity. In practice there may be several hundred rows and columns of pixels. The pixels 12 are addressed via the sets of row and column address conductors by a peripheral drive circuit comprising a column (data) driver circuit 16 and a row, control, driver circuit 17 connected to the ends of the respective sets of conductors.

The active matrix structure is fabricated on a suitable transparent, insulating, support, for example of glass, using thin film deposition and process technology similar to that used in the manufacture of AMLCDs.

Each row of pixels is addressed in turn in a respective row address period by means of control signals applied by the circuit 17 to the relevant row conductors 15 so as to load the pixels of the row with respective data signals, determining their individual display outputs in a frame period following the row address period, according to the respective data signals supplied in parallel by the circuit 16 to the column conductors 14. As each row is addressed, the data signals are supplied by the circuit 16 in appropriate synchronisation.

A further set of conductors extending parallel to the control lines provide power (voltage) supply lines 18, each shared by a respective row of display cells 10 and arranged to supply current to their respective display elements. Each display cell 10 is connected to an associated power line 18. The power lines 18 are held at a constant voltage so as to act as a current source for the electroluminescent display elements and to provide a fixed reference voltage for the driving circuitry. The power lines 18 may instead extend in the column direction with each line then being shared by the display cells in a respective column. Alternatively, power lines may be provided extending in both the row and column directions and interconnected to form a grid structure.

A further set of conductors extending parallel to the control lines 15 provide ground lines 19, each shared by a row of display cells 10 providing a reference, voltage for the address circuitry. An electrode (not shown) continuous and extending over the array and common to all cells 10 within the array may be provided, and held at ground to provide a cathode potential for the electroluminescent display elements and to act as a current drain.

Data signals supplied via the data lines 14 are digital in nature and therefore can be either high or low, for example, in the order of the power line and ground line levels respectively.

FIG. 2 shows the circuit of the first display cell 10 in the series arrangement of a typical pixel in the array of one embodiment of the display device. The electroluminescent display element, referenced at 20, comprises an organic light emitting diode, represented here as a diode element (LED) and comprising a pair of electrodes between which one or more active layers of organic electroluminescent material is sandwiched. The display elements of the array are carried together with the associated address circuitry on one side of an insulating support. Either the cathodes or the anodes of the display elements are formed of transparent conductive material. The support is of transparent material such as glass and the electrodes of the display elements 20 closest to the substrate may consist of a transparent conductive material such as ITO so that light generated by the electroluminescent layer is transmitted through these electrodes and the support so as to be visible to a viewer at the other side of the support.

The cell 10 further comprises driving circuitry for controlling the current through the display element 20 in accordance with an applied data signal. The circuitry comprises p-type and n-type TFTs. The associated ground line 19 and common (cathode) electrode are shown as one line in the Figure as they are held at a similar voltage level. In practice, however, they may be formed separately.

FIG. 2 will now be used to describe the basic operation involving the supply of a data signal to the first cell 10 and the transfer of that signal to the neighbouring cell during a respective row address period. At the start of the row address period, a data signal is supplied from the column driver circuit 16, via the associated data line 14, to a feed line 21 which connects the cell to the data line. The digital state of this data signal represents the desired output of the final cell in the pixel's series arrangement. A first inverter 22 inverts the data signal which is supplied by the feed line 21. The inverter comprises two TFTs, one of p-type conductivity 22a and one of n-type 22b, having their current-carrying terminals connected together in series between power line 18 and ground line 19. The data signal applied to the gates of both TFTs, 22a and 22b, causes one or the other to conduct depending on the state (high/low) of the signal. This produces an inverted signal at the output 23 of the inverter 22. A control signal, in the form of a voltage pulse, from the control driver circuit 17 is supplied, via the control line 15, to the gate of the first control TFT 24. This causes the TFT 24 to switch on (conduct), throughout the duration of the voltage pulse, thus allowing the inverted signal from the output 23 of the first inverter 22 to be applied to the input of a second inverter 26. The second inverter 26 is similar to the first inverter 22 and comprises one p-type TFT 26a and one n-type TFT 26b connected in series between the power line 18 and the ground line 19. The first inverter output (corresponding to the data signal) is inverted back to its original state by this inverter 26 and is supplied from the output 27 of the second inverter 26 to the anode of the LED display element 20.

The display element 20 is arranged such that the anode is connected to the output 27 of the second inverter 26 and the cathode is connected to the ground line 19. Alternatively, as previously mentioned, the cathode may be connected to an electrode common to all display elements in the array and held at the same potential as the ground line 19.

Thus, in response to a high data signal applied at the input 21, a high voltage level, corresponding approximately to the level on the line 18, is applied on the anode of the display element. Conversely, in response to a low data signal applied at the input 21, a low voltage level, corresponding approximately to the level on the line 19, is applied on the anode of the display element.

A high voltage signal at the anode of the display element 20 will cause current to flow therethrough thus switching the display element to an ON-state. A low voltage signal at the anode will result in a negligible potential difference across the display element thus switching it to an OFF-state. The control signal, supplied via the control line 15, also provides a voltage pulse at the gate of a second control TFT 28. The TFT 28 operates complementary to the TFT 24 so that throughout the duration of the pulse, the TFT 28 switches off and the data signal is held at the anode of the display element 20.

When the control signal on the line 15 goes low, i.e. at the end of the voltage pulse, the first control TFT 24 switches off and the second control TFT 28 switches on. The data signal present at the anode of the display element 20 is then transferred to the input of the first inverter of the next cell in the series arrangement. Following this, the (first) data signal is discontinued, by the column driver circuitry 16, from the feed line 21. The next data signal can then be loaded, via the data line 14, onto the feed line 21 ready for the next control pulse in the address period.

The basic operation described above is repeated in respective portions of the address period until all cells in the pixel are loaded with their desired, respective, data signals.

FIG. 3 shows the circuitry of a typical pixel in a slightly modified embodiment of the invention. The pixel 12 here comprises three display cells 10a-c connected together in a series arrangement. Each display cell 10a-c is connected to a control line 15, a power line 18 and a ground line 19 is a similar manner to the embodiment described above. However, FIG. 3 shows the display elements 20a-c connected to a common (cathode) line 31. This is separate from the ground line 19 and serves to provide a current drain for the display elements connected thereto. An associated data line 14 supplies data signals, from the column driver circuitry 16, to the first display cell 10a during a row address period.

FIG. 4 is a diagram showing, for part of a frame period t_{Frame}, the progression of data signals through the pixel 12 of FIG. 3. Six nodes of the circuit are indicated at 41-46, in FIG. 3, each of which corresponds to a plot in FIG. 4. The information contained in the data signals for each of the display cells, 10a, b and c, is indicated in FIG. 4 as blocks A, B and C respectively. In addition, FIG. 4 shows a plot of the control signal pulses, V_{con}, supplied by the associated control line 15 for one row address period.

Referring to both FIGS. 3 and 4, the first display cell 10a is the same in construction and operation to that shown in FIG. 2. Before the start of the row address period, t_{Address}, the data line 14 supplies a data signal C to the feed line 21 (at node 41). This signal is to be transferred, through the series arrangement during the address period, to the last cell 10c in the series, setting the output of that cell to the desired state for the remainder of the frame period.

A first control (voltage) pulse, V_{CON}, is applied to the cells 10a-c, by the row driver circuitry 17 (FIG. 1), via the associated control line 15. This causes data signal C to be transferred to node 42 (the anode of the first display element 10a). On removal of the first control signal, data signal C is further transferred to point 43 (the input of the second display cell 10b). The input data signal C is then removed from the feed line 21.

This process is then repeated in which a data signal B is supplied to the feed line 21 before the application and removal of a second control pulse causes this to transfer to the input of the second display cell 10b. Simultaneously, data signal C is transferred one cell along the series arrangement to the input of the third, and last, display cell 10c (at point 45).

Again, the process is repeated whereby the application and removal of a third control pulse to each cell 10 and the supply of data signal A to feed line 21 results in each of the display cells holding their respective desired data signals at the end of the row address period. The absence of any further control pulses being applied to the associated control line 15 for the remainder of the frame period t_{Frame} results in the display cells 10a-c holding their respective data signals, A, B and C, for this time, i.e. until the next row address period for that row. Therefore, each display element is held in an OFF-state or an ON-state depending on its respective data signal.

Each row of pixels is addressed in turn in this manner in sequence and in respective row address periods so as to load the display elements in each pixel of each row with their respective data signals and set the pixels to provide desired display outputs during the subsequent frame period, until they are next addressed.

To summarise, in the pixel addressing method described above with reference to FIGS. 3 and 4, data signals are supplied to the pixel 12 one at a time in sequence, with the data signal C corresponding to the last display element 10c in the series being supplied first. Corresponding control (voltage) signals are applied to the pixel, in synchronisation with the data signals causing the address circuitry to transfer the data signals A-C along the series arrangement in sequence, to their respective display cell, 10a-c. The arrangement of the address circuitry in the manner of a shift-register in this way, means that the data signals transfer along the series arrangement at both the leading and trailing edges of the control pulses, thus reducing the length of the address period. The data signals A-C hold their respective display element 20a-c in this state for the remainder of the frame period and until that row of pixels is next addressed.

Although particular transistors shown in FIGS. 2 and 3 are of p-type and n-type conductivity, it will be apparent to those skilled in the art that arrangements using the conductivity types opposite to those shown may also be used, with appropriate alterations to the voltages employed. Amorphous silicon or polysilicon TFTs may be used.

Although it is preferred that each column of pixels has an associated, respective data line, it is envisaged that more than one pixel in the same row may be addressed by the same data line. In this case, more data signals will be supplied by each data line during an address period. However, fewer data lines would be required to address the entire display. This alternative approach may be taken to the extreme in which each row of pixels has only one associated data line. Therefore only one data line connected to the first display cell in each row, would be required. However, the address period would be significantly increased in order to load each display cell in a given row with its respective data signal. Further alternative arrangements of the data lines 14 will be apparent to those skilled in the art.

The invention is particularly applicable to active matrix electroluminescent display devices which are addressed with digital data signals and employ an area ratio scheme to achieve grey scale. With such a scheme, the pixels are preferably sub-divided into a plurality of differently sized cells, each cell having a corresponding electroluminescent display element. FIG. 5 shows an example of a pixel 12 having four display elements 20a-d. By forming the display elements of different effective display areas in this way, a greater range of grey scales can be achieved. The first cell 10a in the series arrangement is of the smallest element area with the display elements of subsequent cells increasing in area along the series. During an address period, the pixel is loaded with data signals which are transferred along the series arrangement. The display elements of the cells may be caused to flicker as data signals are momentarily held at the anodes of the corresponding display elements. Therefore, in a preferred embodiment, the cells are sized in this way so as to minimise the visible flicker during address periods.

Various other pixel configurations are also possible, as will be apparent to those skilled in the art.

Although the above embodiments have been described with reference to organic electroluminescent display elements in particular, it will be appreciated that other kinds of electroluminescent display elements comprising electroluminescent material through which current is passed to generate light output may be used instead.

The display device may be a monochrome or multi-color display device. It will be appreciated that a color display device may be provided by using different light color emitting display elements in the array. The different color emitting display elements may typically be provided in a regular, repeating pattern of, for example, red, green and blue color light emitting display elements.

In summary of the disclosure herein, an active matrix electroluminescent display device comprises a matrix array of display cells arranged in rows and columns, each cell comprising an electroluminescent display element and driving circuitry. The cells are arranged in groups which may constitute pixels. Each group of cells forms a series arrangement arranged so a data signal applied to the first cell in a series arrangement, via an associated data line, can be transferred to a neighbouring cell in the same group, and so on for subsequent cells in the group, upon application of a control signal applied to an associated control line. This device enables a digital drive scheme to be implemented. The provision of grouped display cells arranged so as to be driven in this way enables a grey scale to be implemented using fewer data lines than usual.

From reading the present disclosure, other modifications will be apparent to persons skilled in the art. Such modifications may involve other features which are already known in the design, manufacture and use of active matrix electroluminescent display devices and component parts therefor and which may be used instead of or in addition to features already described herein.

1. An active matrix electroluminescent display device comprising a matrix array of display cells arranged in rows and columns, each cell comprising an electroluminescent display element and driving circuitry for controlling the current through the display element in response to applied data signals, driver means for driving the cells, the cells being organised in groups with each group comprising a plurality of adjacent cells within the same row which are connected in a series arrangement, each group having an associated data line through which data signals are supplied from the driver means, each row of cells having an associated control line through which control signals are supplied from the driver means, wherein the driver means is arranged so as to supply a data signal to the first cell within a group via its associated data line and that first cell is arranged to transfer the data signal to a neighbouring cell in the same group upon application of a control signal to its associated control line.

2. An active matrix electroluminescent display device according to claim 1, wherein, each cell after the first in the series arrangement is adapted so as to receive a data signal from the preceding cell in the series arrangement in response to an applied control signal to the control line.

3. An active matrix electroluminescent display device according to claim 1, wherein cells of each group have an associated power line held at a constant voltage and operable to supply current to the respective display elements.

4. An active matrix electroluminescent display device according to claim 1, wherein the driving circuitry of each cell is arranged so as to switch its associated display element between an off-state and an on-state in accordance with digital data signals supplied to that cell.

5. An active matrix electroluminescent display device according to claim 1, wherein each group of cells constitutes a display pixel.

6. An active matrix electroluminescent display device according to claim 5, wherein the display element in each cell forms a sub-pixel and has an active area different to the other cells.

7. An active matrix electroluminescent display device according to claim 1, wherein each group of cells comprises an entire row of cells.

8. A method of driving an active matrix electroluminescent display device comprising a matrix array of display cells arranged in rows and columns, each cell comprising an electroluminescent display element, the cells being organised in groups, each group comprising a plurality of adjacent cells within the same row and which are connected to their neighbouring cells in a series arrangement and having an associated data line, each row of cells having an associated control line, the method comprising the steps of:
addressing a group of cells in a row with respective data signals by applying a data signal to the first cell in the group via its associated data line; and,
applying a control signal to the row of cells via its associated control line so as to transfer a data signal from one cell to a neighbouring cell in a group.

9. A method of driving an active matrix electroluminescent display device according to claim 8, wherein the method further comprises the steps of:
applying a further data signal to the first cell in each group in that row via the associated data line; and
applying a further control signal to that row via its associated control line so as to cause the first-mentioned data signal and the further data signal to be transferred to respective neighbouring cells in each respective group.

10. A method of driving an active matrix electroluminescent display device according to claim 8, wherein the data signals are digital.

11. A method of driving an active matrix electroluminescent display device according to claim 10, wherein each group constitutes a pixel in which the cells within the group form sub-pixels and are driven between on and off states.
